(19) United States
(12) Patent Application Publication
(10) Pub. No.: US 2022/0372381 A1
(43) Pub. Date: Nov. 24, 2022

(54) INTEGRATED SLURRY HYDROPROCESSING CATALYST AND PROCESS

(71) Applicant: Saudi Arabian Oil Company, Dhahran (SA)

(72) Inventor: Ki-Hyouk Choi, Dhahran (SA)

(73) Assignee: Saudi Arabian Oil Company, Dhahran (SA)

(21) Appl. No.: 17/328,667

(22) Filed: May 24, 2021

(51) Int. Cl. C10G 45/16; C10G 45/26; C10G 7/04

(52) U.S. Cl. CPC C10G 45/16; C10G 45/26; C10G 7/04; C10G 2300/4037; C10G 2300/805; C10G 2300/70; C10G 2300/4006; C10G 2300/4012; C10G 2300/107

(57) ABSTRACT

An integrated catalytic process for upgrading a feed oil comprises the steps of introducing a catalyst precursor solution to a supercritical water (SCW) process unit, where the catalyst precursor solution comprises a catalyst precursor dissolved in liquid water; introducing a feed water to the SCW process unit; introducing the feed oil to the SCW process unit; treating the catalyst precursor solution, the feed water, and the feed oil in the SCW process unit to produce a SCW effluent, where the catalyst precursor is converted to catalyst particles; separating the SCW effluent in a separator unit to produce a SCW distillate product, a SCW residue product; introducing the SCW residue product to a slurry hydroprocessing unit, where the SCW residue product comprises the catalyst particles; treating the SCW residue product and the hydrogen gas in the slurry hydroprocessing unit to produce a product gas stream and an upgraded oil product.

### TECHNICAL FIELD

Disclosed are methods for upgrading oil. Specifically, disclosed are methods and systems for upgrading heavy oil with catalysts produced in situ.

### BACKGROUND

Catalytic hydroprocessing process (CHP) is one of the primary refining processes to upgrade and desulfurize low-value fractions of crude oil to produce valuable fuels and chemical feedstocks. In a catalytic hydroprocessing process, catalysts facilitate the reaction of molecular hydrogen with hydrocarbons, which results in lightening of heavy molecules and removal of heteroatoms. In spite of recent progress of catalyst development, catalyst deactivation is one of major restrictions in improving performance of catalytic hydroprocessing process. Hydroprocessing catalysts are deactivated by poisoning, coking, sintering, and mechanical disintegration. Typical feedstock to catalytic hydroprocessing process contains various poisonous materials such as nitrogen compounds, metallic compounds, and polyaromatic hydrocarbons (PAH). Such materials adsorb on the catalyst surface to cause irreversible deactivation. After a period of time, deactivated catalysts must be regenerated or replaced with fresh catalysts.

In order to manage such an inevitable catalyst deactivation, refining industry has developed certain measures to prolong the catalyst life. These measures include pretreating the feed to a CHP to remove poisonous materials, such as removal of nitrogen compounds by adsorption, and adopting harsh reaction conditions, such as high hydrogen pressure, to mitigate deactivation of catalyst. Continuous or frequent replacement of the catalysts is also a way to maintain high performance of a CHP without shut-down of the process for replacing entire catalyst beds.

In spite of such efforts, the life time of catalytic reactor beds is still limited by the amounts of metals in the feed that can be processed. The limit on the amount of metal in the feed in fixed-bed hydroprocessing processes is less than 100 wt ppm metals, in ebullated-bed processes is less than 500 wt ppm, and in slurry hydroprocessing processes (SHP) the limit is a few thousands wt ppm of metals.

Slurry hydroprocessing process (SHP) has been developed to process bottom fractions of crude oil which contain large amounts of catalyst poisons such as metals, asphaltenes, and polyaromatic hydrocarbons (PAH). In SHP, thermal cracking occurs along with catalytic hydrotreating and catalytic hydrocracking. Catalysts, generally present in fine particles, prevent coke formation by hydrogenating thermally cracked molecules quickly. In most of the developed SHP, the feed, hydrogen and catalysts flows through reactors in upflow mode to maintain a better mix of ingredients. Operating conditions are generally 400-500° C. and 150-270 bar with liquid hourly space velocity (LHSV) of 0.05 to 0.75 per hour. SHP has superior performance to conventional fixed-bed and ebullated-bed hydroprocessing process. Conversion of heavy-ends, hydrocarbons having a boiling point of 1050° F. or greater, reaches 90% while desulfurization and demetallization are greater than 80%. Such performances are feasible with higher liquid product yield, greater than 90% to 95%, than conventional thermal cracking.

To optimize performance of SHP, catalysts must be well dispersed in the oil matrix. In most cases, catalysts can be classified into two groups: homogeneous catalysts and heterogeneous catalysts. Homogeneous catalysts, are defined as catalysts fully miscible with reactants and products. In SHP, homogeneous catalysts, which are dissolved in the oil matrix, are based on organometallic compounds. Homogeneous catalysts can be introduced into the process by two ways, water-soluble catalysts and oil-soluble catalysts. Water-soluble catalyst precursors are introduced to the process. Water in this case is a vehicle to bring the catalyst precursors into the vicinity of hydrocarbons or one of the activating chemicals which are required to convert water-soluble catalyst precursors into active catalysts. In oil-soluble catalyst, organometallic compounds, which have high miscibility with hydrocarbons, are provided as a catalyst or catalyst precursor. Examples of such organometallic and oleophilic compounds are Mo-dithiocarbamate (Mo-DTC) and Mo-dithiophosphate (Mo-DTP). Such compounds are decomposed in the SHP conditions and converted to active catalysts, such as MoS₂ in the reactor.

Heterogeneous type catalysts are mostly shaped fine particles, which allows dispersion of catalysts in the oil matrix and enhances catalyst activity. In SHP, catalysts flow through the reactor once, meaning no direct recycling back to the reactor. For saving catalysts, catalyst containing fraction of SHP product can be recycled back to the feed for re-use of catalysts with minor make-up of catalysts. In spite of improvement of catalyst lifetime in the process through process modification and optimization, it has much shorter time of usage than fixed-bed catalysts. From economic viewpoint, cheap materials containing active ingredients are preferred as slurry catalysts. For example, limonite and iron ore have been used for slurry bed hydrocracking processes after being crushed into fine particles. Although such bulk materials are much cheaper than well-designed catalysts such as impregnated catalysts, activity is limited from dominant non-active portion of the materials. To compensate for low activity, a large amount of catalyst is required to achieve desired upgrading. To overcome such limitations, nano-sized catalysts have been employed. Nano-sized catalysts expose active sites preferentially due to high surface to volume ratio.

Nano-sized catalysts for use in SHP can be produced by sol-gel methods, spray pyrolysis methods, and mechanical pulverizing method.

Another process for upgrading hydrocarbons is supercritical water process, which is a thermal cracking process where weak chemical bonds are broken to produce smaller molecules. The temperatures in supercritical water processes are enough to break certain chemical bonds in crude oil and its fractions, but the extent of upgrading is not substantial when compared with a delayed coking process. Also, supercritical water does not achieve high desulfurization because of strong bonds of carbon-sulfur in aromatic sulfur compounds, a major sulfur species in crude oil, especially heavy fractions. Upgrading in supercritical water process is further limited because reaction temperatures and residence times are limited to prevent coke formation. Additionally, recombination of broken chemical bonds through radical reactions is inevitable.

Process scheme optimization and modification could improve upgrading performance of supercritical water process, but catalysts could overcome the limitations. Catalysts can lower activation barrier of reactions under supercritical conditions and at the same time generate hydrogen through steam reforming reactions between water and hydrocarbons. However, low hydrothermal stability of most of catalytic materials makes the use of catalysts in supercritical water processes challenging. The harsh condition of supercritical water shortens the catalyst life time and deteriorates the physical integrity of catalysts.

Additionally, the harsh conditions of supercritical water require catalysts to have high hydrothermal resistance, which exclude the use of homogeneous catalysts, because homogeneous catalysts are easily converted to other forms and loose catalytic activity in supercritical water process conditions. Heterogeneous catalysts, defined as catalysts in a separate phase reactants and products, exhibit relatively superior stability under supercritical water conditions. Heterogeneous catalysts can be deployed in several types of reactors, including fixed bed, ebullated-bed, and fluidized-bed reactors.

However, these reactors are not readily applicable to supercritical water-heavy oil systems. First, because large molecules in the heavy oil have limited access to active sites in the catalyst pore structure due to their large kinematic diameters. In fixed bed reactors, the molecules must approach the active sites in the pore structure of the catalyst through diffusion barriers. Second, pressure drop can develop quickly through the catalyst bed, which results in undesired shut-down of the process. Third, ebullated-bed and fluidized-bed reactors have complicated flow paths which can be difficult to adapt to high pressure and high temperature reactor systems as would be required in a supercritical water process.

Additionally, it must be pointed out that heterogeneous catalysts may not have sufficient stability in supercritical water to exhibit activity for long periods of time, such as for a year or longer. Thus, requiring regeneration at frequent periods.

Slurry-bed reactors can overcome the limitations of fixed bed, ebullated bed and fluidized bed reactors. In a slurry-bed reactor, catalysts are continuously discharged from and injected into the reactor. Thus, the catalysts do not experience long exposure to harsh conditions of supercritical water and a slurry-bed reactor continuously has fresh catalyst, although some amount of catalyst can be gradually deactivated through the reactor. Due to the well-dispersed state of catalyst and fine size of catalyst particles, large molecules in the heavy oil can access active sites relatively easily and without diffusion barriers. Slurry-bed reactors have been employed for hydrocracking of residue fraction. However, slurry-bed reactors have their own set of requirements.

The catalysts must be small in size to flow with fluids smoothly and to allow easy access of reactant molecules to actives sites on the catalyst particles. This requirement limits the concentration of catalyst (wt of catalyst/wt of reactor internal fluid) in the slurry-bed reactors, which limits the kinetics. The catalysts must be well dispersed in the fluid for exerting catalytic effect to the entire volume of reactants. Finally, the catalysts must be easily separated from the products.

### SUMMARY

Disclosed are methods for upgrading oil. Specifically, disclosed are methods and systems for upgrading heavy oil with catalysts produced in situ.

In a first aspect, an integrated catalytic process for upgrading a feed oil is provided. The integrated catalytic process includes the steps of introducing a catalyst precursor solution to a supercritical water (SCW) process unit, where the catalyst precursor solution includes a catalyst precursor dissolved in liquid water, introducing a feed water to the SCW process unit, introducing the feed oil to the SCW process unit, treating the catalyst precursor solution, the feed water, and the feed oil in the SCW process unit to produce a SCW effluent, where the catalyst precursor is converted to catalyst particles in the SCW process unit, separating the SCW effluent in a separator unit to produce a SCW product gas, a SCW distillate product, a SCW residue product, and a water product, introducing the SCW residue product to a slurry hydroprocessing unit, where the SCW residue product includes the catalyst particles, introducing a hydrogen gas to the slurry hydroprocessing unit, and treating the SCW residue product and the hydrogen gas in the slurry hydroprocessing unit to produce a product gas stream and an upgraded oil product.

In certain aspects, the integrated catalytic process further includes the steps of mixing the feed water with the catalyst precursor solution in a catalyst mixer to produce a metal-containing water stream, increasing a pressure of the metal-containing water stream in a water pump to produce a pressurized water stream, increasing a temperature of the pressurized water stream in a water preheater to produce a supercritical water stream, where the supercritical water stream is at a temperature between 374° C. and 500° C. and a pressure between 22 MPa and 35 MPa, where the catalyst precursor is converted to the catalyst particles in the water preheater such that the supercritical water stream includes water at supercritical conditions and the catalyst particles, where the catalyst particles include metal oxides, where the Reynolds number of the pressurized water stream is greater than 6,000, increasing a pressure of the feed oil in an oil pump to produce a pressurized oil stream, where the feed oil includes heavy oil, increasing a temperature of the pressurized oil stream in an oil preheater to produce a hot oil stream, mixing the supercritical water stream and the hot oil stream in a mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1, introducing the mixed stream to a reactor, where the reactor is operated at a temperature between 380° C. and 500° C. and a pressure between 22 MPa and 35 MPa, processing the heavy oil in the reactor in the presence of the catalyst particles to produce a reactor effluent, where the catalyst particles catalyze upgrading reactions of the heavy oil, reducing a temperature of the reactor effluent in a cooling unit to produce a cooled effluent, and reducing a pressure of the cooled effluent in a pressure let-down device to produce the SCW effluent. In certain aspects, the integrated catalytic process further includes the steps of increasing a pressure of the catalyst precursor solution in a precursor pump to produce a pressurized precursor solution, increasing a pressure of the feed water in a water pump to produce a pressurized feed water, increasing a temperature of the pressurized feed water in a water preheater to produce a supercritical water feed, mixing the supercritical water feed with the pressurized precursor solution in a catalyst mixer to produce a supercritical water stream, where the supercritical water stream is at a temperature between 374° C. and 500° C. and a pressure between 22 MPa and 35 MPa, withdrawing the supercritical water stream to a process line connecting the catalyst mixer to a mixer, where the catalyst precursor is converted to catalyst particles in the process line such that the supercritical water stream includes water at supercritical conditions and the catalyst particles, where the catalyst particles include metal oxides, where the Reynolds number of the supercritical water stream in the process line is greater than 6,000, where the residence time in the process line is between 0.05 minutes and 10 minutes. In certain aspects, the integrated catalytic process further includes the steps of mixing the supercritical water feed with the pressurized precursor solution in a catalyst mixer to produce a supercritical water stream, where the supercritical water stream is at a temperature between 300° C. and 370° C. and a pressure between 22 MPa and 35 MPa, introducing the supercritical water stream to a catalyst heater, increasing a temperature of the supercritical water stream in the catalyst heater to produce a catalyst-containing water, where the catalyst precursor is converted to catalyst particles in the catalyst heater such that the catalyst-containing water includes water at supercritical conditions and the catalyst particles, where the catalyst particles include metal oxides, where the Reynolds number of the supercritical water stream in the catalyst heater is greater than 6,000, where the temperature of the catalyst-containing water is in the range between 374° C. and 500° C. In certain aspects, the integrated catalytic process further includes the steps of introducing the supercritical water stream to a catalyst pressure control, reducing a pressure of the supercritical water stream in the catalyst pressure control to produce a pressure regulated catalyst stream, where the catalyst precursor is converted to catalyst particles in the process line downstream of the catalyst pressure control such that the pressure regulated catalyst stream includes water at supercritical conditions and the catalyst particles, where the catalyst particles include metal oxides, where the Reynolds number of the pressure regulated catalyst stream is greater than 6,000, where the temperature of the pressure regulated catalyst stream is in the range between 374° C. and 500° C., oil such that the pressure of the pressurized precursor solution and the pressurize feed water is at least 0.1 MPa greater than the pressure of the pressurized oil stream. In certain aspects, the catalyst precursor includes a cation and an anion. In certain aspects, the cation is selected from the group consisting of transition metals from periods 4 to 6, groups 4 to 12 of the periodic table, cerium, and combinations of the same. In certain aspects, the anion is selected from the group consisting of sulfates, chlorides, acetates, acetyl acetonate, formates and combinations of the same. In certain aspects, the integrated catalytic process further includes the steps of mixing the hydrogen gas and a hydrogen recycle stream in a hydrogen mixer to produce a hydrogen feed, compressing the hydrogen feed to produce a compressed hydrogen feed, mixing the SCW residue product with a residue recycle in a residue mixer to produce a residue feed, increasing a pressure of the residue feed in a residue pump to produce a pressurized residue feed, introducing the hydrogen feed to a slurry reactor, introducing the pressurized residue feed to the slurry reactor, treating the residue feed in the presence of hydrogen and the catalyst particles in the slurry reactor to produce a slurry effluent, and separating the slurry effluent in a fractionator unit to produce the product gas stream and the upgraded oil product.

In a second aspect, an integrated catalytic system for upgrading a feed oil is provided. The integrated catalytic system includes a supercritical water (SCW) process unit, the SCW process unit configured to treat a catalyst precursor solution, a feed water, and the feed oil to produce a SCW effluent, where a catalyst precursor solution includes a catalyst precursor dissolved in liquid water, where the catalyst precursor is converted to catalyst particles in the SCW, a separator unit fluidly connected to the SCW process unit, the separator unit configured to separate the SCW effluent to produce a SCW product gas, a SCW distillate product, a SCW residue product, and a water product, where the SCW residue product includes the catalyst particles, and a slurry hydroprocessing unit fluidly connected to the separator unit, where slurry hydroprocessing unit is configured to treat the SCW residue product and a hydrogen gas to the slurry hydroprocessing unit to produce a product gas stream and an upgraded oil product.

In certain aspects, the system further includes a catalyst mixer configured to mix the feed water with the catalyst precursor solution to produce a metal-containing water stream, a water pump fluidly connected to the catalyst mixer, the water pump configured to increase a pressure of the metal-containing water stream to produce a pressurized water stream, a water preheater fluidly connected to the water pump, the water preheater configured to increase a temperature of the pressurized water stream to produce a supercritical water stream, where the supercritical water stream is at a temperature between 374° C. and 500° C. and a pressure between 22 MPa and 35 MPa, where the catalyst precursor is converted to the catalyst particles in the water preheater such that the supercritical water stream includes water at supercritical conditions and the catalyst particles, where the catalyst particles comprise metal oxides, where the Reynolds number of the pressurized water stream is greater than 6,000, an oil pump configured increase a pressure of the feed oil to produce a pressurized oil stream, where the feed oil includes heavy oil, an oil preheater fluidly connected to the oil pump, the oil preheater configured to increase a temperature of the pressurized oil stream to produce a hot oil stream, a mixer configured to mix the supercritical water stream and the hot oil stream to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1, a reactor fluidly connected to the mixer, the reactor configured to process the heavy oil in the presence of the catalyst particles to produce a reactor effluent, where the catalyst particles catalyze upgrading reactions of the heavy oil, where the reactor is operated at a temperature between 380° C. and 500° C. and a pressure between 22 MPa and 35 MPa, a cooling unit fluidly connected the reactor, the cooling unit configured to reduce a temperature of the reactor effluent to produce a cooled effluent, and a pressure let-down device fluidly connected to the cooling unit, the pressure let-down device configured to reduce a pressure of the cooled effluent to produce the SCW effluent. In certain aspects, the system further includes a precursor pump, the precursor pump configured to increase a pressure of the catalyst precursor solution to produce a pressurized precursor solution, a water pump configured to increase a pressure of the feed water to produce a pressurized feed water, a water preheater fluidly connected to the water pump, the water preheater configured to increase a temperature of the pressurized feed water in to produce a supercritical water feed, a catalyst mixer, the catalyst mixer configured to mix the supercritical water feed with the pressurized precursor solution to produce a supercritical water stream, where the supercritical water stream is at a temperature between 374° C. and 500° C. and a pressure between 22 MPa and 35 MPa, a process line connecting the catalyst mixer to a mixer, where the catalyst precursor is converted to catalyst particles in the process line such that the supercritical water stream includes water at supercritical conditions and the catalyst particles, where the catalyst particles include metal oxides, where the Reynolds number of the supercritical water stream in the process line is greater than 6,000, where the residence time in the process line is between 0.05 minutes and 10 minutes. In certain aspects, the integrated catalytic system further includes a catalyst heater fluidly connected to the catalyst mixer, the catalyst heater configured to increase a temperature of the supercritical water stream to produce a catalyst-containing water, where the catalyst precursor is converted to catalyst particles in the catalyst heater such that the catalyst-containing water includes water at supercritical conditions and the catalyst particles, where the catalyst particles include metal oxides, where the Reynolds number of the supercritical water stream in the catalyst heater is greater than 6,000, where the temperature of the catalyst-containing water is in the range between 374° C. and 500° C. In certain aspects, the integrated catalytic system further includes a catalyst pressure control fluidly connected to the catalyst mixer, the catalyst pressure control configured to reduce a pressure of the supercritical water stream to produce a pressure regulated catalyst stream, where the catalyst precursor is converted to catalyst particles in the process line downstream of the catalyst pressure control such that the pressure regulated catalyst stream includes water at supercritical conditions and the catalyst particles, where the catalyst particles include metal oxides, where the Reynolds number of the pressure regulated catalyst stream is greater than 6,000, where the temperature of the pressure regulated catalyst stream is in the range between 374° C. and 500° C., where the pressure of the pressurized precursor solution and the pressurize feed water is at least 0.1 MPa greater than the pressure of the pressurized oil stream, where the feed oil includes heavy oil. In certain aspects, the integrated catalytic system further includes a hydrogen mixer configured to mix the hydrogen gas and a hydrogen recycle stream to produce a hydrogen feed, a compressor fluidly connected to the hydrogen mixer, the compressor configured to compress the hydrogen feed to produce a compressed hydrogen feed, a residue mixer configured to mix the SCW residue product and a residue recycle to produce a residue feed, a residue pump fluidly connected to the residue mixer, the residue pump configured to increase a pressure of the residue feed to produce a pressurized residue feed, a slurry reactor, the slurry reactor configured to treat the residue feed in the presence of the hydrogen gas and the catalyst particles to produce a slurry effluent, and a fractionator unit fluidly connected to the slurry reactor, the fractionator unit configured to separate the slurry effluent to produce the product gas stream and the upgraded oil product.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 provides a process diagram of an embodiment of the system and process for upgrading heavy oil with in situ produced catalyst particles.

FIG. 2 provides a process diagram of an embodiment of the system and process for upgrading heavy oil with in situ produced catalyst particles.

FIG. 3 provides a process diagram of an embodiment of the system and process for upgrading heavy oil with in situ produced catalyst particles.

FIG. 4 provides a process diagram of an embodiment of the system and process for upgrading heavy oil with in situ produced catalyst particles.

FIG. 5 provides a process diagram of an embodiment of the system and process for upgrading heavy oil with in situ produced catalyst particles.

FIG. 6 provides a graphical representation of the relationship between pressure and temperature on the ionic product of supercritical water.

FIG. 7 provides a process diagram of an embodiment of the system and process for upgrading heavy oil with in situ produced catalyst particles.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The system and methods described integrate catalytic upgrading of heavy oil in supercritical water and slurry hydroprocessing. More specifically, the system and methods employ an in situ method to produce metal oxide catalysts with the aid of supercritical water, which then is a reaction medium for upgrading and desulfurization reactions of heavy oil in supercritical water followed by slurry hydroprocessing.

Advantageously, the integrated system and process with in situ produced catalyst can improve the upgrading and desulfurization performance of supercritical water process by employing the catalysts to create a feed to a slurry hydroprocessing using the in situ produced catalyst. Advantageously and unexpectedly, the disclosed methods produce in situ catalysts used for exerting catalytic effect for upgrading and desulfurization of heavy oil in both supercritical water process and slurry hydroprocessing. Advantageously, partial upgrading heavy oil in catalytic supercritical water process creates a feed for a slurry hydroprocessing process. Advantageously, using in situ produced catalysts first in a supercritical water process creates a feed to the slurry hydroprocessing process with a well dispersed catalyst particles. Advantageously, transferring catalysts from the supercritical water process to the slurry hydroprocessing process reduces the load on the slurry hydroprocessing process which reduces capital and operating costs.

Advantageously, in situ produced catalyst particles do not suffer disadvantages of ex situ catalysts. Ex situ produced nano-sized or submicron-sized inorganic powders tend to form aggregates from static or chemical interaction in air or water during storage or before use. Once aggregated, it is difficult to disperse such powdered catalyst to primary particle levels. Aggregated particles, in spite of no change in chemical structure, show lower catalytic activity due to lowered surface area.

Advantageously and unexpectedly, using catalyst particles immediately after synthesis without a change in operating conditions reduces or eliminates the aggregations of the catalyst particles.

As used throughout “residence time” is calculated by assuming the density of the internal fluid in a vessel, pipe, tubular, or other process unit is the same as pure water at the operating conditions of the vessel, pipe, tubular, or other process unit.

As used throughout “Reynolds number” is calculated by assuming the density of the internal fluid in a vessel, pipe, tubular, or other process unit is the same as pure water at the operating conditions of the vessel, pipe, tubular, or other process unit.

As used throughout, “bottom fraction” refers to the fraction of an oil stream having a boiling point greater than 650° F., alternately greater than 1050° F., alternately greater than 1200° F., and alternately between 1050° F. and 1200° F.

As used throughout, “external supply of hydrogen” refers to the addition of hydrogen to the feed to the reactor or to the reactor itself. For example, a reactor in the absence of an external supply of hydrogen means that the feed to the reactor and the reactor are in the absence of added hydrogen, gas (H₂) or liquid, such that no hydrogen (in the form H₂) is a feed or a part of a feed to the reactor.

As used throughout, “ex situ catalyst” refers to catalyst prepared external to the upgrading process and added to one of the fluid streams.

As used throughout, “residue fraction” refers to the fraction of an oil stream having T5 of greater than 644° F., alternately a T10 of greater than 644° F., and alternately a T15 of greater than 644° F.

As used throughout, “supercritical water” refers to water at a temperature at or greater than the critical temperature of water and at a pressure at or greater than the critical pressure of water. The critical temperature of water is 373.946° C. The critical pressure of water is 22.06 megapascals (MPa). It is known in the art that hydrocarbon reactions in supercritical water upgrade heavy oil and crude oil containing sulfur compounds to produce products that have lighter fractions. Supercritical water has unique properties making it suitable for use as a petroleum reaction medium where the reaction objectives can include conversion reactions, desulfurization reactions denitrogenation reactions, and demetallization reactions. Advantageously, at supercritical conditions water acts as both a hydrogen source and a solvent (diluent) in conversion reactions, desulfurization reactions and demetallization reactions and a catalyst is not needed. Hydrogen from the water molecules is transferred to the hydrocarbons through direct transfer or through indirect transfer, such as the water-gas shift reaction. In the water-gas shift reaction, carbon monoxide and water react to produce carbon dioxide and hydrogen. The hydrogen can be transferred to hydrocarbons in desulfurization reactions, demetallization reactions, denitrogenation reactions, and combinations.

As used throughout, “coke” refers to the toluene insoluble material present in petroleum.

As used throughout, “cracking” refers to the breaking of hydrocarbons into smaller ones containing few carbon atoms due to the breaking of carbon-carbon bonds.

As used throughout, “upgrade” or “upgrading” means one or all of increasing API gravity, decreasing the amount of heteroatoms, including sulfur atoms, nitrogen atoms, metal atoms, and oxygen atoms, decreasing the amount of asphaltene, increasing the middle distillate yield, decreasing the viscosity, and combinations of the same, in a process outlet stream relative to the process feed stream. One of skill in the art understands that upgrade can have a relative meaning such that a stream can be upgraded in comparison to another stream, but can still contain undesirable components such as heteroatoms.

As used throughout, “upgrading reactions” refers to reactions that can upgrade a hydrocarbon stream including cracking, isomerization, oligomerization, dealkylation, dimerization, aromatization, cyclization, desulfurization, denitrogenation, deasphalting, demetallization, and combinations of the same.

It is known in the art that hydrocarbon reactions in supercritical water upgrade heavy oil and crude oil containing sulfur compounds to produce products that have lighter fractions. Supercritical water has unique properties making it suitable for use as a petroleum reaction medium where the reaction objectives can include conversion reactions, desulfurization reactions denitrogenation reactions, and demetallization reactions. Supercritical water is water at a temperature at or greater than the critical temperature of water and at a pressure at or greater than the critical pressure of water. The critical temperature of water is 373.946° C. The critical pressure of water is 22.06 megapascals (MPa). Advantageously, at supercritical conditions water acts as both a hydrogen source and a solvent (diluent) in conversion reactions, desulfurization reactions and demetallization reactions and a catalyst is not needed. Hydrogen from the water molecules is transferred to the hydrocarbons through direct transfer or through indirect transfer, such as the water-gas shift reaction. In the water-gas shift reaction, carbon monoxide and water react to produce carbon dioxide and hydrogen. The hydrogen can be transferred to hydrocarbons in desulfurization reactions, demetallization reactions, denitrogenation reactions, and combinations of the same. The hydrogen can also reduce the olefin content. The production of an internal supply of hydrogen can reduce coke formation.

Without being bound to a particular theory, it is understood that the basic reaction mechanism of supercritical water mediated petroleum processes is the same as a free radical reaction mechanism. Radical reactions include initiation, propagation, and termination steps. With hydrocarbons, initiation is the most difficult step and conversion in supercritical water can be limited due to the high activation energy required for initiation. Initiation requires the breaking of chemical bonds. The bond energy of carbon-carbon bonds is about 350 kJ/mol, while the bond energy of carbon-hydrogen is about 420 kJ/mol. Due to the chemical bond energies, carbon-carbon bonds and carbon-hydrogen bonds do not break easily at the temperatures in a supercritical water process, 380° C. to 450° C., without catalyst or radical initiators. In contrast, aliphatic carbon-sulfur bonds have a bond energy of about 250 kJ/mol. The aliphatic carbon-sulfur bond, such as in thiols, sulfide, and disulfides, has a lower bond energy than the aromatic carbon-sulfur bond.

Thermal energy creates radicals through chemical bond breakage. Supercritical water creates a “cage effect” by surrounding the radicals. The radicals surrounded by water molecules cannot react easily with each other, and thus, intermolecular reactions that contribute to coke formation are suppressed. The cage effect suppresses coke formation by limiting inter-radical reactions. Supercritical water, having a low dielectric constant compared to liquid phase water, dissolves hydrocarbons and surrounds radicals to prevent the inter-radical reaction, which is the termination reaction resulting in condensation (dimerization or polymerization). Moreover, the dielectric constant of supercritical water can be tuned by adjusting the temperature and pressure. Because of the barrier set by the supercritical water cage, hydrocarbon radical transfer is more difficult in supercritical water as compared to conventional thermal cracking processes, such as delayed coker, where radicals travel freely without such barriers.

The following embodiments, provided with reference to the figures, describe the process to produce in situ catalyst particles and upgrade a heavy oil.

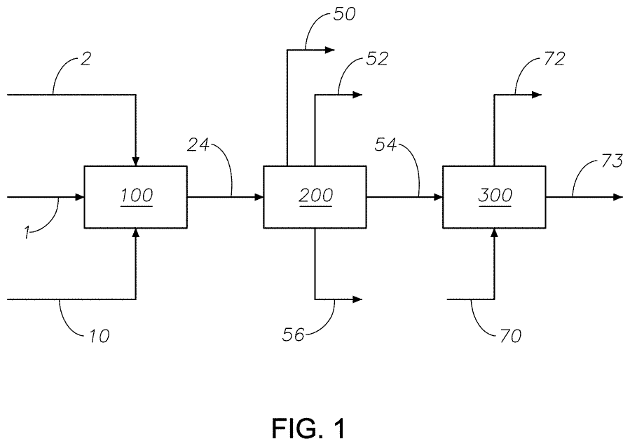

Referring to FIG. 1 an embodiment of the integrated catalytic process and system for upgrading heavy oil with in situ produced catalyst particles is provided.

Feed water 1 is introduced to supercritical water process unit 100 along with catalyst precursor solution 2 and feed oil 10.

Feed water 1 contains water. Feed water 1 can be any source of water having a conductivity less than 1 microsiemens (μS)/centimeter (cm), alternately less than 0.5 μS/cm, and alternately less than 0.1 μS/cm. Examples of sources of feed water 1 include demineralized water, distilled water, boiler feed water (BFW), deionized water, and combinations of the same.

Catalyst precursor solution 2 contains a catalyst precursor dissolved in liquid water. The catalyst precursor can be any ionic compound containing a cation and an anion. Examples of cations suitable for use include transition metals from periods 4 to 6, groups 4 to 12 of the periodic table, cerium, and combinations of the same. In at least one embodiment, the cations include transition metals from period 4, groups 4 to 12, alone or in combination. In at least one embodiment, the cations include chromium, iron, cobalt, nickel, copper, zinc, molybdenum, and combinations of the same. In at least one embodiment, the cations include iron, nickel, molybdenum, and combinations of the same. Examples of anions include nitrates, sulfates, chlorides, acetates, acetyl acetonate (acac), formates and combinations of the same. In at least one embodiment, the anionic compounds include nitrate, acetate, acetyl acetonate, and combinations of the same. In at least one embodiment, the catalyst precursor includes a molybdate anion and an ammonium-containing cation as a precursor to forming molybdenum compounds. Molybdenum compounds can include molybdenum trioxide. The cation concentration, including metallic cations, in the catalyst precursor solution can be in the range of 0.07 mM to 7.3 M. The anion concentration, including metallic anions, can be in the range of 0.07 mM to 7.3 M. Catalyst precursor solution 2 is in the absence of liquid acids, liquid alkalis, alcohols, hydrogen peroxides, or combinations of the same. Examples of liquid acids include acrylic acid. Catalyst precursor solution 2 is in the absence of solid sediments.

Both feed water 1 and catalyst precursor solution 2 can be at ambient conditions and alternately at a pressure between ambient pressure and 0.1 MPa. Alternately, feed water 1 can be at a temperature between ambient temperature and 100° C. The operating conditions of feed water 1 and catalyst precursor solution 2 depend on the source from which the feed water 1 and catalyst precursor solution 2 were pulled, such as storage tanks. The operating temperature of catalyst precursor solution 2 can be heated to aid in dissolving the catalyst precursor in the liquid water, however the temperature is maintained at less than 100° C. The temperature of catalyst precursor solution 2 is maintained at less than 100° C. to keep the water in the liquid state.

The ratio of the mass flow of feed water 1 to catalyst precursor solution 2 is in the range of 1:0.05 to 1:1, alternately in the range of 1:0.1 to 1:1. In at least one embodiment, the ratio of the mass flow of feed water 1 to catalyst precursor solution 2 is 1:0.1.

Feed oil 10 can be any type of heavy oil stream containing a residue fraction. Examples of oil streams suitable for use as feed oil 10 include whole range crude oil, distilled crude oil, reduced crude oil, topped crude oil, residue oil, product streams from oil refineries, product streams from steam cracking processes, liquefied coals, liquids recovered from oil or tar sands, bitumen, shale oil, asphaltene, biomass hydrocarbons, liquids recovered from plastic pyrolysis, and combinations of the same. Feed oil 10 can contain at least 10 wt %, alternately at least 25 wt %, alternately between 10 wt % and 100 wt %, and alternately between 25 wt % and 100 wt % residue fraction. Feed oil 10 can be at a temperature between ambient and 250° C. The temperature of feed oil 10 can be elevated above ambient to reduce the viscosity to make feed oil 10 pumpable.

Feed water 1, catalyst precursor solution 2 and feed oil 10 are processed in supercritical water process unit 100 to produce supercritical water (SCW) effluent 24. Supercritical water process unit 100 increases the distillate range fraction relative to the amount in feed oil 10. SCW effluent 24 can be introduced to separator unit 200.

Separator unit 200 can be any type of separator vessel capable of separating a hydrocarbon-containing stream into separate fractions. Separator unit 200 can include a separator capable of separating multiple phases simultaneously or can be a combination of two or more separators. Separator unit 200 includes a distillation column and a distillation column in combination with at least one additional separation vessel. The at least one additional separation vessel can include a flash column, a gas-liquid separator, a liquid-liquid separator, and combinations of the same. In embodiments where separator unit 200 includes a liquid-liquid separator, a demulsifier can be added to separator unit 200 to enhance the separation of oil and water. In at least one embodiment, separator unit 200 is a distillation column that separates SCW effluent 24 according to boiling point. SCW effluent 24 is separated in separator unit 200 to produce SCW product gas 50, product water 56, SCW distillate product 52, and SCW residue product 54. Separating SCW effluent 24 in separator unit 200 removes the distillate range fractions from the residue range fractions.

SCW product gas 50 is in the absence of catalyst particles.

Product water 56 can be subjected to a water treatment unit to produce a treated water stream. The water treatment unit can be any type of treatment system for removing impurities from a water stream. In at least one embodiment, the water treatment unit is a membrane-based process deploying multiple membrane units. Examples of impurities that can be removed in the water treatment unit include solids, organic compounds, and inorganic compounds. The treated water can be reused in the process or disposed of. The amount of catalyst particles in product water 56 can be less than 1 wt % and alternately less than 0.1 wt %. In at least one embodiment, the amount of catalyst particles in product water 56 is less than 0.1 wt %. Catalyst particles can be surrounded by hydrocarbons, which are adsorbed on the catalyst particles, making the catalyst particles hydrophobic, which reduces the amount of catalyst particles in product water 56.

SCW distillate product 52 can contain distillate range hydrocarbon fractions having boiling points less than 370° C. The true boiling point (TBP) of SCW distillate product 52 is a T85 less than 370° C., alternately a T90 less than 370° C., and alternately a T95 less than 370° C. SCW distillate product 52 is in the absence of catalyst particles.

SCW residue product 54 can contain residue range hydrocarbons having boiling points greater than 340° C. The TBP of SCW residue product 54 is a T5 of greater than 340° C., alternately a T10 of greater than 340° C., and alternately a T15 of greater than 340° C. In at least one embodiment, the TBP of SCW residue product 54 is a T10 of greater than 343° C. SCW residue product 54 can be in the range of 10% by weight to 70% by weight of SCW effluent 24. The catalyst particles in supercritical water process unit 100 are concentrated in SCW residue product 54. The catalysts accumulate in the residue range fraction and are contained in SCW residue product 54. SCW residue product 54 has a concentration of catalyst particles in the range of 500 wt ppm (0.05 wt %) and 8.000 wt ppm (0.8 wt %).

SCW residue product 54 can be introduced to slurry hydroprocessing unit 300 along with hydrogen gas 70. A pump and heat exchanger can deployed on the process line transferring SCW residue product 54 from separator unit 200 to slurry hydroprocessing unit 300. The pump can be any type of pump capable of moving the fluid. The heat exchanger can be any type of heater unit capable of increasing a temperature of SCW residue product 54. The heat exchanger can reduce viscosity to make SCW residue product 54 pumpable. SCW residue product 54 can be at a temperature in the range between 50° C. and 300° C. and a pressure in the range between 0.05 MPa and 1 MPa.

Hydrogen gas 70 can be any stream containing at least 99.5 wt % hydrogen gas.

SCW residue product 54 and hydrogen gas 70 are treated in slurry hydroprocessing unit 300 to produce product gas stream 72 and upgraded oil product 73.

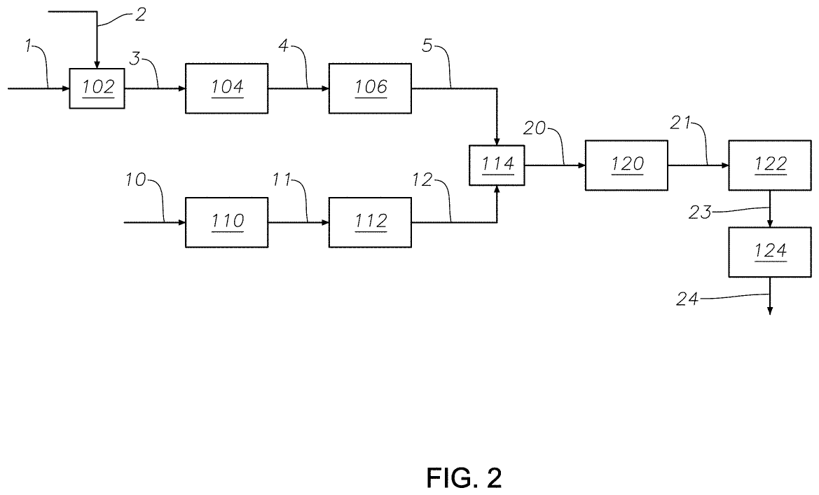

Referring to FIG. 2, an embodiment of supercritical water process unit 100 is provided with reference to FIG. 1.

Feed water 1 is introduced to catalyst mixer 102 along with catalyst precursor solution 2. Feed water 1 and catalyst precursor solution 2 are mixed in catalyst mixer 102 to produce metal-containing water 3. Catalyst mixer 102 can be any type of mixing unit capable of mixing two streams. Examples of catalyst mixer 102 includes inline mixer, T-fitting, Y-fitting, and combinations of the same.

Metal-containing water 3 can be pressurized in water pump 104 to produce pressurized water stream 4. Water pump 104 can be any type of pump capable of increasing a pressure of a water stream. The pressure of pressurized water stream 4 can be in the range between 22 MPa and 35 MPa and alternately in the range between 23 MPa and 28 MPa. Pressurized water stream 4 can be introduced to water preheater 106.

The temperature of pressurized water stream 4 can be increased in water preheater 106 to produce supercritical water stream 5. Catalyst precursor in pressurized water stream 4 can be converted to catalyst particles in water preheater 106.

Supercritical water serves as an excellent solvent for producing sub-micron sized metal oxide particles in a short amount of time, on the order of minutes. When a solute's concentration increases beyond the solubility concentration (Cs), supersaturation state is achieved. Further increases of the solute concentration over critical nucleation concentration (Cₘᵢₙ) initiates nuclei formation. Due to consumption of solute into nuclei, the solute concentration decreases below Cₘᵢₙ and growth of particles starts by adsorption of solute into the nuclei, Ostwald ripening (redissolution of small nuclei and depositing into the larger nuclei), and coalescence of small nuclei into large particles. In order to produce fine particles having narrow size distribution, the nucleation rate must be significantly faster than the growth rate. In other words, growth of particles must be suppressed while nucleation is accelerated. In conventional hydrothermal methods, it can take a long time to increase solute concentration, which is typically done by heating. This means that under conventional methods, solute concentration may stay below the critical nucleation concentration (Cₘᵢₙ) for significant periods and the growth stage dominates the particle production process.

Supercritical water serves an excellent solvent because it can induce “explosive” nucleation due to its low dielectric constant where ionic compounds have very low solubility. Under normal conditions, metals salts completely dissolve in liquid water. At supercritical conditions, metal salts are precipitated due to low dielectric constant of supercritical water. The abrupt change of solubility induces sudden nucleation in a very short amount of time.

The small particle size and narrow size distribution of catalyst particles produced in supercritical water is further enabled because any metal hydroxide, the product of the hydrolysis of metal salts, produced is consumed in the production of metal oxides. The small particle size of the catalyst particles are suitable for use in slurry hydroprocessing process.

By the above described process, the catalyst precursor in the catalyst precursor solution is converted to catalyst particles. The catalyst particles are metal oxides. The catalyst particles are in the absence of metal sulfides, organometallic compounds, organically modified metal oxide, and combinations of the same. Converting catalyst precursor to catalyst particles is in the absence of added hydrogen and hydrogen sulfide.

Water preheater 106 can be any type of vessel, pipe, or tubular capable of increasing a temperature of an internal fluid and maintaining a Reynolds number of the internal fluid of greater than 6,000, alternately greater than 10,000, alternately between 6,000 and 100,000, and alternately between 10,000 and 100,000. The upper limit of Reynolds number can be determined by pressure drop through water preheater 106. Maintaining a Reynolds number greater than 6,000 ensures dispersion of the catalyst precursor and catalyst particles in the supercritical water. Examples of water preheater 106 can include electric heater, heat exchanger, and combinations of the same. The residence time of the internal fluid in water preheater 106 can be between 0.05 minutes and 10 minutes, and alternately between 0.1 minutes and 5 minutes. In at least one embodiment, the residence time of the internal fluid in water preheater 106 is between 0.1 minutes and 5 minutes. The temperature of supercritical water stream 5 can be in the range between 374° C. and 500° C., and alternately between 400° C. and 450° C. Maintaining a temperature in water preheater 106 between 374° C. and 500° C. avoids complete conversion of the metal catalyst precursors to catalyst oxide particles. Supercritical water stream 5 contains the catalyst precursor, catalyst particles, and water at supercritical conditions. Supercritical water stream 5 can be introduced to mixer 114.

The residence time of fluid in the process line from the exit of water preheater to inlet of the reactor is less than 0.1 minutes. This includes the residence time of the fluid through mixer 114.

Feed oil 10 can be introduced to oil pump 110. The pressure of feed oil 10 can be increased in oil pump 110 to produce pressurized oil stream 11. Oil pump 110 can be any type of pump capable of pumping a heavy oil stream. The pressure of pressurized oil stream 11 can be between 22 MPa and 35 MPa, and alternately between 23 MPa and 28 MPa. Pressurized oil stream 11 can be introduced to oil preheater 112.

The temperature of pressurized oil stream 11 can be increased in oil preheater 112 to produce hot oil stream 12. Oil preheater 112 can be any type of heat exchanger capable of increasing a temperature of a heavy oil stream. The temperature of hot oil stream 12 can be in the range between 100° C. and 250° C. Hot oil stream 12 can be introduced to mixer 114.

The mass flow ratio of supercritical water stream 5 to hot oil stream 12 can be in the range of 0.1:1 and 10:1, and alternately in the range of 2:1 and 10:1. In at least one embodiment, the mass flow ratio of supercritical water stream 5 to hot oil stream 12 is 2:1. The mass flow ratio of supercritical water stream 5 to feed water 1 can be in the range of 1.05:1 to 2:1, and alternately in the range of 1.1:1 and 2:1. The mass flow ratio of hot oil stream 12 to catalyst precursor solution 2 can be in the range of 1:0.005 to 1:5, and alternately in the range of 1:0.182 to 1:5. In at least one embodiment, the mass flow ratio of hot oil stream 12 to catalyst precursor solution 2 is in the range of 1:0.182.

The mass ratio of metal oxide to hot oil stream 12 is in the range of 0.00005:1 and 0.005:1, and alternately in the range of 0.0005:1 to 0.005:1. The weight percent of metal oxide relative to the weight of hot oil stream 12 is in the range from 0.005 wt % (50 ppm wt) to 0.498 wt % (4975 ppm wt). In at least one embodiment weight percent of metal oxide relative to the weight of hot oil stream 12 is 0.050 wt % (500 ppm wt). Table 1 contains examples of how the mass ratio of metal oxide to hot oil stream 12 translates to molar concentration of the cationic compounds titanium and molybdenum as the catalyst precursor. The atomic mass of titanium is 47.84 and the formula weight of titanium dioxide is 79.82 g/mol. The atomic mass of molybdenum is 96 and the formula weight for molybdenum trioxide is 143.97 g/mol.

TABLE 1

| | | Total weight | Wt ratio of | |
|---|---|---|---|---|
| | Wt ratio | of catalyst | metal oxide | |
| | metal oxide | precursor | to catalyst | Molar concentration |
| | to hot oil | solution 2 | precursor | of cation in catalyst |
| | stream 12 | (kg) | solution 2 | precursor solution 2 |
| Ti | 0.00005 to 1 | 0.004762 | 0.00001 to 1 | 0.0001 |
| Ti | 0.0005 to 1 | 0.181818 | 0.00275 to 1 | 0.0345 |
| Ti | 0.005 to 1 | 5 | 1.05 to 1 | 13.1546 |
| Mo | 0.00005 to 1 | 0.004762 | 0.00001 to 1 | 0.00007 |
| Mo | 0.0005 to 1 | 0.181818 | 0.00275 to 1 | 0.01910 |
| Mo | 0.005 to 1 | 5 | 1.05 to 1 | 7.29319 |

Supercritical water stream 5 and hot oil stream 12 can be mixed in mixer 114 to produce mixed stream 20. Mixer 114 can be any type of mixer capable of mixing a hot oil stream and a supercritical water stream. Examples of mixer 114 include t-fitting mixer, y-fitting mixer, a line mixer, and combinations of the same. The temperature of mixed stream 20 is at a temperature between 320° C. and 370° C.

Mixing the hot oil stream 12 and supercritical water stream 5 brings the hydrocarbons in contact with the supercritical water. Not all hydrocarbon fractions in hot oil stream 5 can be dissolved in the supercritical water of supercritical water stream 5. In particular, the asphaltenic fraction is not fully soluble in supercritical water. The catalyst particles are denser than the phase of hydrocarbons dissolved in the supercritical water. Thus, as the two streams mix, the catalyst particles will mix with the fractions that do not dissolve in supercritical water, namely the asphaltenic fraction. Advantageously, the dissolved hydrocarbons of hot oil stream 20 do not require catalyst to be upgraded and do not bond to or modify the surface of the catalyst particles. Hydrocarbons dissolved in supercritical water can be upgraded without the help of catalyst. Mixed stream 20 can be introduced to reactor 120.

Reactor 120 can be any type of reactor capable of maintaining catalytic reactions. In at least one embodiment, reactor 120 is a slurry-bed reactor. In reactor 120, the catalyst particles catalyze upgrading reactions, including demetallization reactions, denitrogenation reactions, and desulfurization reactions of the hydrocarbons from feed oil 10. Without being bound to a particular theory, it is believed that catalysts in supercritical water facilitate cracking through oxidative mechanisms, where active oxygen, generated from the water, on the catalyst, induce bond cleave to form a radical, which is then capped by hydrogen from the water. The production of coke is reduced or eliminated in reactor 120.

Reactor 120 can be any type of vessel capable of acting as a slurry-bed reactor. Examples of vessels suitable for use as a slurry-bed reactor include a tubular reactor, vessel reactor, a continuous stirred tank reactor (CSTR), and combinations of the same. In at least one embodiment, reactor 120 is a tubular reactor where fluid flows downward. Reactor 120 is in the absence of externally provided hydrogen. Reactor 120 is in the absence of externally provided hydrogen sulfide. Reactor 120 can be designed to have Reynolds greater than 6,000, and alternately 10,000. The residence time of reactor 120 is in the range of 0.1 and 60 minutes, and alternately in the range of 1 minutes and 10 minutes. The temperature in reactor 120 can be between 380° C. and 500° C., and alternately between 380° C. and 450° C. The pressure in reactor 120 can be between 22 MPa and 35 MPa, and alternately between 23 MPa and 28 MPa. In at least one embodiment, reactor 120 is at a temperature between 380° C. 450° C. and at a pressure between 23 MPa and 28 MPa. Catalytic reactions of heavy oil occur in reactor 120 to produce reactor effluent 21.

The process lines, such as the piping, valves, and fittings, connecting water preheater 106, mixer 114, and reactor 120 can be designed to have a Reynolds number greater than 6,000 and alternately greater than 10,000. In at least one embodiment, the Reynolds number is greater than 10,000.

Reactor effluent 21 can be introduced to cooling unit 122. Cooling unit 122 can be any type of unit that can reduce the temperature of a reactor effluent. Examples of cooling unit 122 include a heat exchanger, an air cooler, and combinations of the same. Examples of heat exchanger include a shell-and-tube type exchanger, a double-pipe type exchanger, and combinations of the same. In embodiments where cooling unit 122 is a shell and tube type heat exchanger, reactor effluent 21 is introduced through the tube side to reduce or prevent the sedimentation of catalysts, which would occur on the shell side of the heat exchanger. Cooling unit 122 is designed to have a Reynolds number greater than 6,000 and alternately greater than 10,000. The temperature of reactor effluent 21 can be reduced in cooling unit 122 to produce cooled effluent 23. The temperature of cooled effluent can be less than 374° C., alternately between 150° C. and 374° C., and alternately between 150° C. and 350° C.

The process lines, such as the piping, valves, and fittings, connecting reactor 120 and cooling unit 122 can be designed to have a Reynolds number greater than 6,000 and alternately greater than 10,000.

Cooled effluent 23 is introduced to pressure let-down device 124. Pressure let-down device 124 can be any type of unit capable of reducing the pressure of a stream containing solid particles. Examples of pressure let-down device 124 include a dome-type back pressure regulator, multistage pressure regulator, a pressure control valve, and combinations of the same. In at least one embodiment, pressure let-down device 124 is a multi-stage pressure regulator where the pressure is reduced in multiple stages. The pressure of cooled effluent 23 is reduced in pressure let-down device 124 to produce SCW effluent 24. The pressure of SCW effluent 24 is between ambient pressure and 0.5 MPa.

SCW effluent 24 can be introduced to separator unit 200.

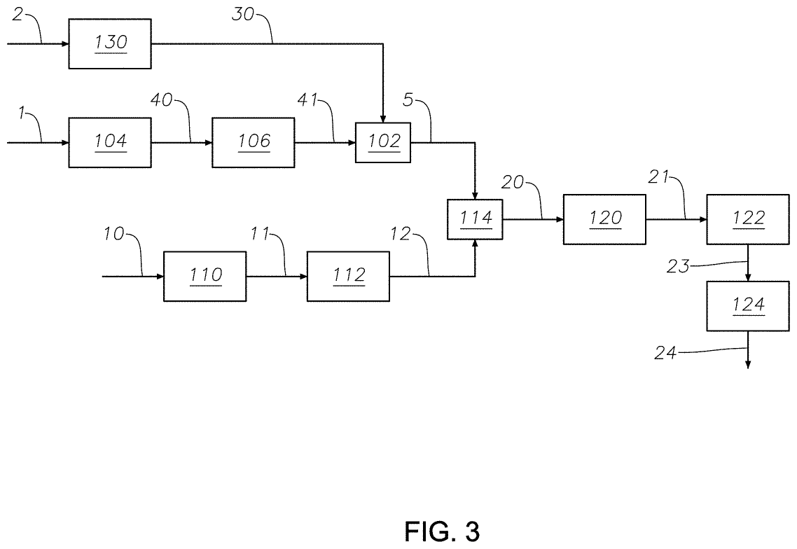

Referring to FIG. 3, an embodiment of supercritical water process unit 100 is provided with reference to FIG. 2.

The pressure of feed water 1 is increased in water pump 104 to produce pressurized feed water 40. The temperature of pressurized feed water 40 is increased in water preheater 106 to produce supercritical feed water 41. Water pump 104 and water preheater 106 are described with reference to FIG. 1. Supercritical feed water 41 is at supercritical conditions, such that the water in supercritical feed water 41 is supercritical water. The temperature of supercritical feed water 41 can be between 400° C. and 600° C. The temperature of supercritical feed water 41 is adjusted such that supercritical water stream 5 is at a temperature between 374° C. and 500° C., and alternately between 400° C. and 450° C. The temperature of supercritical feed water 41 and supercritical water stream 5 can be adjusted based on feedback from instruments that measure temperature. Supercritical feed water 41 is introduced to catalyst mixer 102.

The pressure of catalyst precursor solution 2 is increased in precursor pump 130 to produce pressurized precursor solution 30. Precursor pump 130 can be any type of pump capable of increasing the pressure of a fluid. The pressure of pressurized precursor solution 30 can be in the range from 22 MPa to 35 MPa. Pressurized precursor solution 30 is introduced to catalyst mixer 102 to produce supercritical water stream 5.

In embodiments described with reference to FIG. 3, the catalyst particles are formed in the process line between catalyst mixer 102 and mixer 114 through which supercritical water stream 5 flows. The process line can be designed to have a Reynolds number greater than 6,000 and alternately greater than 10,000. The residence time of the internal fluid in the process line through which supercritical water stream 5 flows can be in the range of 0.05 minutes to 10 minutes, and alternately between 0.1 minutes and 5 minutes. The embodiment described with reference to FIG. 3, ensures the catalysts are generated before contacting the feed oil from feed oil 10. In the embodiment described with reference to FIG. 3, catalyst particles are not present in supercritical water feed 41, but are only produced in after pressurized precursor solution 30 is mixed with supercritical feed water 41 to produce supercritical water stream 5.

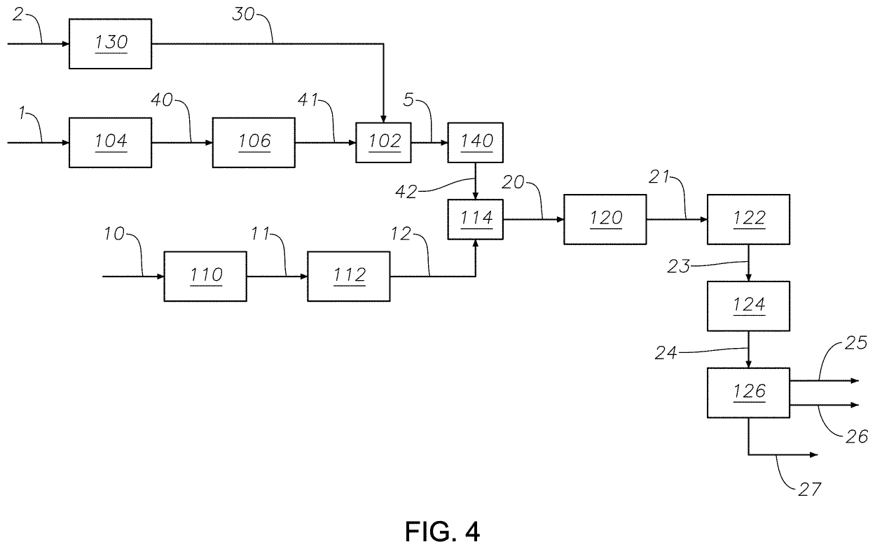

Referring to FIG. 4, an alternate embodiment of the supercritical water process unit 100 is provided with reference to FIG. 2 and FIG. 3.

The temperature of supercritical feed water 41 is adjusted such that supercritical water stream 5 has a temperature between 300° C. and 370° C., and alternately between 350° C. and 370° C. The near critical conditions, where pressure is greater than the critical pressure of water and temperature is less than the critical temperature of water, enhances hydrolysis because of low pKw, high concentration of OH—, of water in the near critical region. The process line connecting catalyst mixer 102 and catalyst heater 140 is designed to maintain a Reynolds of the flow of supercritical water stream 5 greater than 6,000 and alternately greater than 10,000. The residence time in the process line between catalyst mixer 102 and catalyst heater 140 is between 0.01 minutes and 10 minutes, and alternately between 0.1 minutes and 2 minutes. Supercritical water stream 5 is introduced to catalyst heater 140.

Catalyst heater 140 can be any type of unit capable of increasing a temperature of an internal fluid stream. Examples of units suitable for use as catalyst heater 140 include electric heater, heat exchanger, and combinations of the same. The temperature of supercritical water stream 5 is increased in catalyst heater 140 to produce catalyst-containing water 42. The temperature of catalyst-containing water 42 can be in the range between 374° C. and 500° C., and alternately 400° C. and 450° C. Catalyst precursor in supercritical water stream 5 can be converted to catalyst particles in catalyst heater 140. The residence time of the internal fluid from the inlet of catalyst heater 140 to the inlet of mixer 114 can be in the range of 0.05 minutes to 10 minutes, and alternately between 0.1 minutes and 5 minutes.

Catalyst-containing water 42 is introduced to mixer 114.

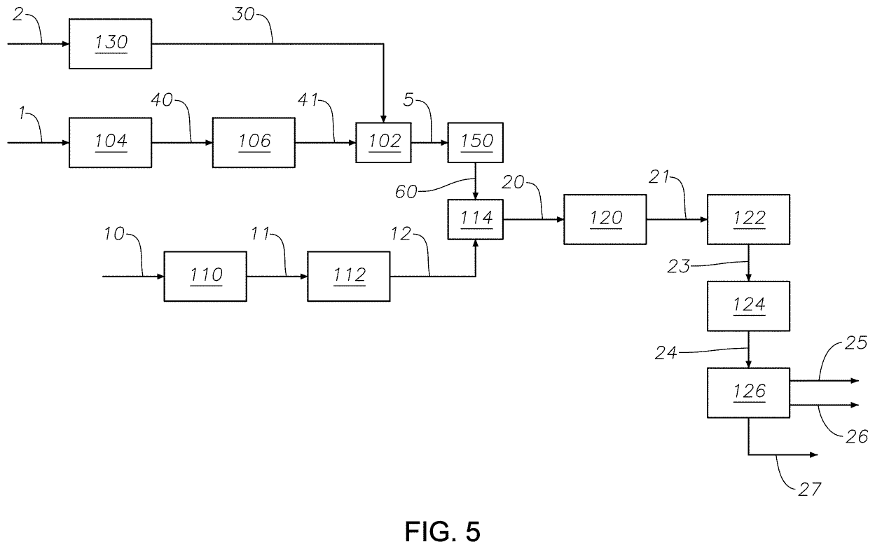

Referring to FIG. 5, an alternate embodiment of the supercritical water process unit 100 is provided with reference to FIG. 3 and FIG. 4.

The pressure of both pressurized precursor solution 30 and pressurized feed water 40 is adjusted to be at least 0.1 MPa greater than the pressure of pressurized oil stream 11, and alternately greater than 0.2 MPa greater than the pressurized oil stream 11. As a result, the pressure of pressurized precursor solution 30, pressurized feed water 40, supercritical feed water 41, and supercritical water stream 5 are greater than the pressure of hot oil stream 12, mixed stream 20, and pressure regulated catalyst stream 60. Supercritical water stream 5 is introduced to catalyst pressure control 150.

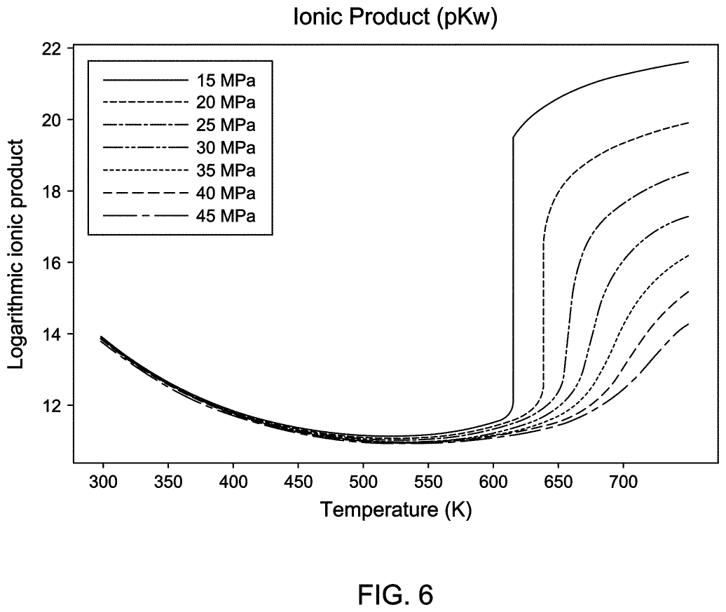

Catalyst pressure control 150 can be any type of pressure device that can control the pressure of a fluid stream. Examples of catalyst pressure control 150 include pressure control valve and back pressure regulator. Catalyst pressure control 150 operates to maintain a pressure in supercritical water stream 5 that is greater than the pressure in pressure regulated catalyst stream 60. As shown in FIG. 6, there is a relationship between pressure and pKw, with increased pressure resulting in reduced pKw, which means more hydroxide (OH⁻) in the supercritical water.

Operating the step of converting the catalyst precursor to catalyst particles at an increased pressure relative to upgrading the heavy oil in reactor 120 is advantageous because the operating conditions in reactor 120 can be optimized. Reducing the pressure through catalyst pressure control 150 reduces the ionic property of supercritical water resulting in improved behavior of the supercritical water as a solvent for upgrading the hydrocarbons from oil feed 10.

Catalyst precursor is converted to catalyst particles in the process line connecting catalyst mixer 102 to catalyst pressure control 150 and in the process line connecting catalyst pressure control 150 to mixer 114. Both supercritical water stream 5 and pressure regulated catalyst stream 60 contain catalyst precursor, catalyst particles, and water at supercritical conditions. The residence time of the internal fluid from the outlet of catalyst mixer 102 to the inlet of mixer 114 is between 0.05 minutes and 10 minutes, and alternately between 0.1 minutes and 5 minutes. In at least one embodiment, the residence time of supercritical water stream 5 in the process line connecting catalyst mixer 102 and catalyst pressure control 150 is between 0.05 minutes and 5 minutes and the residence time of pressure regulated catalyst stream 60 in the process line connecting catalyst pressure control 150 and mixer 114 is between 0.1 minutes and 7 minutes.

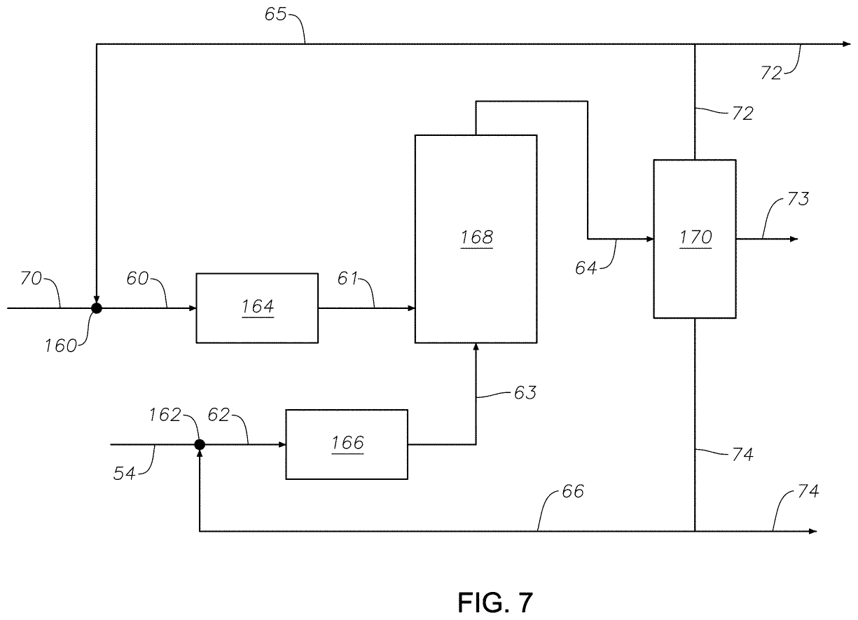

Referring to FIG. 7, an embodiment of slurry hydroprocessing unit 300 is described with reference to FIG. 1.

Slurry hydroprocessing unit 300 can be any type of slurry hydroprocessing unit. Slurry hydroprocessing unit 300 can include compressor 164, feed pump 166, slurry reactor 168, and fractionator 170.

Hydrogen gas 70 can be mixed with hydrogen recycle stream 65 in hydrogen mixer 160 to produce hydrogen feed 60. The pressure of hydrogen feed 60 is increased in compressor 164 to produce compressed hydrogen feed 61. Compressed hydrogen feed 61 can be in the range between 0.5 MPa and 25 MPa.

SCW residue product 54 is mixed with residue recycle 66 in residue mixer 162 to produce residue feed 62. Residue feed 62 can be at a temperature between 100° C. and 450° C. and a pressure between 0.05 MPa and 1 MPa. Residue feed 62 is in the absence of distillate range hydrocarbon fractions. Residue feed 62 can be introduced to feed pump 166. The pressure of residue feed 62 can be increased in feed pump 166 to produce pressurized residue feed 63. Pressurized residue feed 63 can be at a temperature between 100° C. and 450° C. and 0.5 MPa and 25 MPa.

Pressurized residue feed 63 and compressed hydrogen feed 61 can be introduced to slurry reactor 168. The mass flow ratio of compressed hydrogen feed 61 to pressurized residue feed 63 is 150 Nm³/m³ and 2000 Nm³/m³, and alternately between 500 Nm³/m³ and 1,500 Nm³/m³. Slurry reactor 168 can be operated at a temperature between 300° C. and 550° C., and alternately between 350° C. and 480° C. Slurry reactor 168 can be operated at a pressure between 0.5 MPa and 25 MPa. Slurry reactor 168 can be operated in upflow mode. Slurry reactor 168 can be designed such that the liquid hourly space velocity (LHSV) of between 0.01 hr-1 and 5 hr-1, and alternately between 0.08 hr-1 and 1.5 hr-1. Slurry reactor 168 is in the absence of water, and alternately the amount of water in slurry reactor 168 is between 100 wt ppm and 1000 wt ppm. Water is to be avoided in slurry reactor 168. Without being bound to a particular theory, catalysts in slurry reactor 168 provide active hydrogen from dissociative adsorption of molecular hydrogen to reactants which are adsorbed on the catalyst. Advantageously, the high hydrogen pressure in slurry reactor 168 can reactivate catalyst to the extent the catalyst is covered in polyaromatic hydrocarbons, which are coke precursors.

The catalyst particles in pressurized residue feed 63 catalyze reactions in slurry reactor 168 to produce slurry effluent 64. Slurry effluent 64 can be at a temperature between 300° C. and 550° C. and a pressure between 0.5 MPa and 25 MPa. Slurry effluent 64 can be transferred to fractionator 170.

Fractionator 170 can separate slurry effluent 64 based on boiling point. Slurry effluent 64 can be separated in fractionator 170 to produce product gas stream 72, upgraded oil product 73, and hydroprocessing residue product 74. Upgraded oil product 73 can be in the range between 100° C. and 400° C. hydroprocessing residue product 74 can be in the range between 250° C. and 400° C. and at a pressure of 0.05 MPa and 1 MPa.

A portion of product gas stream 72 can be separated and treated in a purification unit before being recycled as hydrogen recycle stream 65 can be separated from product gas stream 72. The ratio of hydrogen recycle stream 65 depends on the hydrogen consumption, which depends on the feed to slurry hydroprocessing unit 300.

Residue recycle 66 can be separated from hydroprocessing residue product 74. The ratio of residue recycle 66 to SCW residue product 54 is in the range between 0 and 0.9, meaning that the flow rate of residue recycle 66 is between zero flow and 90% of the flow of SCW residue product 54. In an alternate embodiment, the ratio of residue recycle 66 to SCW residue product 54 is in the range between 0.2 and 0.7. Residue recycle 66 includes catalyst particles.

The system and process for upgrading heavy oil with in situ produced catalyst is in the absence of externally added catalyst, including ex situ produced catalyst. The catalyst particles present in reactor were produced in situ. The catalyst precursor in the catalyst precursor solution does not possess catalytic properties. The catalyst particles are formed in the operating units or piping connecting the units and are not separated or recovered from the aqueous stream before entering the reactor. The catalyst particles are not formed directly from compounds or complexes present in the feed oil. The system and process for upgrading heavy oil with in situ produced catalyst is in the absence of incorporating the catalyst precursor or catalyst particles directly into the feed oil. In the system and process for upgrading heavy oil with in situ produced catalyst described here, the catalyst particles are not produced in a stream containing feed oil and are produced before the water containing catalyst precursor and catalyst particles are mixed with the feed oil. The number of catalyst precursors that can completely dissolve in feed oil is limited and conversion of catalyst precursors to catalyst particles requires water at supercritical conditions. Thus, incorporating the catalyst precursor in the feed oil would not produce catalyst particles before being injected into the reactor. The system and process for upgrading heavy oil with in situ produced catalyst is in the absence of added organic modifiers separate from the feed oil. The slurry hydroprocessing unit is in the absence of added steam.

### EXAMPLES

Example 1 was modeled on FIG. 1 and FIG. 2. Feed oil 10 was an atmospheric residue from crude oil having the properties shown in Table 2.

TABLE 2
Properties of Feed Oil

| Property | Unit | Value |
|---|---|---|
| Specific Gravity | API Gravity | 12.2 |
| Total Sulfur | wt % sulfur | 3.61 |
| Conradson Carbon Residue | Wt % | 8.5 |
| Nitrogen | Wt ppm | 1830 |
| Vanadium | Wt ppm | 18 |
| Nickel | Wt ppm | 11 |
| Distillation(ASTM D7169) | | |
| 5% | Degree C. | 356 |
| 10% | Degree C. | 387 |
| 30% | Degree C. | 459 |
| 50% | Degree C. | 519 |
| 70% | Degree C. | 584 |
| 90% | Degree C. | 675 |
| 95% | Degree C. | 707 |

The catalyst precursor was ammonium heptamolybdate tetrahydrate((NH₄)₆Mo₇O₂₄.4H₂O). Catalyst precursor solution 2 was prepared by dissolving the ammonium heptamolybdate tetrahydrate in water resulting in catalyst precursor solution 2 having 0.015 Mole of molybdenum ion/Liter of aqueous solution. The flow rates and operating conditions of the streams are shown in Table 3. The amount of catalyst precursor was 0.487 kg MoO₃/1000kg of feed oil. The catalyst content was about 490 wt ppm of feed oil 10.

TABLE 3
Process Operating Conditions

| | | Mass | | |
|---|---|---|---|---|
| | | Flow | Temperature | Pressure |
| Stream | | (kg/hour) | (° C.) | (MPa) |
| 1 | Feed Water | 121.8 | 25 | 0.01 |
| 3 | Metal-containing water | 136.4 | 25 | 27.0 |
| 4 | Pressurized water stream | 136.4 | 25 | 27.0 |
| 2 | Catalyst Precursor Solution | 14.6 | 25 | 0.01 |
| 5 | Supercritical Water Stream | 136.4 | 475 | 27.0 |
| 10 | Feed Oil | 64.1 | 95 | 0.2 |
| 11 | Pressurized Oil Stream | 64.1 | 95 | 27.0 |
| 12 | Hot Oil Stream | 64.1 | 185 | 27.0 |
| 20 | Mixed Stream | 200.5 | 409 | 27.5 |
| 21 | Reactor Effluent | 200.5 | 445 | 26.8 |
| 23 | Cooled Effluent | 200.5 | 123 | 26.7 |
| 24 | SCW Effluent | 200.5 | 85 | 0.34 |

Reactor 120 was a tubular reactor. The residence time in reactor 120 was estimated to be about 2.9 minutes. The residence time of supercritical water stream 4 was 0.23 minutes. Separator unit 200 was a distillation column. SCW distillate product 52 is a distillate range fraction having a boiling point distribution between 25° C. and 500° C. SCW residue product 54 is a residue range fraction. The amounts are shown in Table 4.

TABLE 4
Product mass flow

| | Mass |
|---|---|
| | Flow |
| Stream | (kg/hr) |
| SCW product gas 50 | 16.8 |
| SCW distillate product 52 | 39.9 |
| SCW residue product 54 | 22.6 |
| Product water 56 | 121.2 |

The liquid yield was about 97.5 wt %. Feed oil 10 had a residue fraction of about 75.2 wt % and it was reduced to about 36.1 wt %. The properties of SCW distillate product 52 and SCW residue product 54 are shown in Table 5.

TABLE 5
Properties

| | | SCW Distillate | SCW Residue |
|---|---|---|---|
| Property | Unit | Product 52 | Product 54 |
| Specific Gravity | API Gravity | 21.0 | 9.6 |
| Total Sulfur | wt % sulfur | 0.34 | 2.91 |
| Conradson Carbon | Wt % | 21.0 | 15.2 |
| Residue | | | |
| Nitrogen | Wt ppm | 215 | 1191 |
| Vanadium | Wt ppm | 55 | 12.5 |
| Nickel | Wt ppm | 11 | 10.7 |
| Distillation (ASTM | | | |
| D7169) | | | |
| 5% | Degree C. | 246 | 469 |
| 10% | Degree C. | 316 | 495 |
| 30% | Degree C. | 391 | 545 |
| 50% | Degree C. | 420 | 577 |
| 70% | Degree C. | 462 | 607 |
| 90% | Degree C. | 494 | 688 |
| 95% | Degree C. | 496 | 727 |

21 grams of SCW residue product was added to a batch reactor with a 250 mL volume. The internal atmosphere was replaced with nitrogen by flushing, then the reactor temperature was increased to 150° C. while stirring at 600 rpm. Purging with nitrogen was repeated 10 times to remove air in the reactor and trace amounts of water in the residue product.

After completion of the purging with nitrogen, the batch reactor was cooled to around 50° C. Then, the internal atmosphere was replaced with hydrogen by flushing while stirring at 600 rpm. Reactor was pressurized with hydrogen to reach 90 barg while stirring at 600 rpm. Reactor temperature was increased to 390° C. at the rate of 5° C./min while stirring at 600 rpm.

After 2 hours, the reactor was cooled to room temperature while stirring at 600 rpm. Product was recovered after releasing pressure. The liquid product was recovered with 94 wt % yield and properties shown in Table 6.

TABLE 6
Properties of SHP Product.

| Property | Unit | Value |
|---|---|---|
| Specific Gravity | API Gravity | 22.4 |
| Total Sulfur | wt % sulfur | 0.17 |
| Conradson Carbon | Wt % | 0.30 |
| Residue | | |
| Nitrogen | Wt ppm | 131.05 |
| Vanadium | Wt ppm | <0.5 |
| Nickel | Wt ppm | <0.5 |
| Distillation(ASTM | | |
| D7169) | | |
| 5% | Degree C. | 135 |
| 10% | Degree C. | 212 |
| 30% | Degree C. | 301 |
| 50% | Degree C. | 367 |
| 70% | Degree C. | 430 |
| 90% | Degree C. | 524 |
| 95% | Degree C. | 590 |

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

1. An integrated catalytic process for upgrading a feed oil, the integrated catalytic process comprises the steps of:
introducing a catalyst precursor solution to a supercritical water (SCW) process unit, where the catalyst precursor solution comprises a catalyst precursor dissolved in liquid water;
introducing a feed water to the SCW process unit;
introducing the feed oil to the SCW process unit;
treating the catalyst precursor solution, the feed water, and the feed oil in the SCW process unit to produce a SCW effluent, where the catalyst precursor is converted to catalyst particles in the absence of added hydrogen and hydrogen sulfide;
separating the SCW effluent in a separator unit to produce a SCW product gas, a SCW distillate product, a SCW residue product, and a water product;
introducing the SCW residue product to a slurry hydroprocessing unit, where the SCW residue product comprises the catalyst particles;
introducing a hydrogen gas to the slurry hydroprocessing unit; and
treating the SCW residue product and the hydrogen gas in the slurry hydroprocessing unit to produce a product gas stream and an upgraded oil product.

2. The integrated catalytic process of claim 1, further comprising the steps of:
mixing the feed water with the catalyst precursor solution in a catalyst mixer to produce a metal-containing water stream;
increasing a pressure of the metal-containing water stream in a water pump to produce a pressurized water stream;
increasing a temperature of the pressurized water stream in a water preheater to produce a supercritical water stream, where the supercritical water stream is at a temperature between 374° C. and 500° C. and a pressure between 22 MPa and 35 MPa, where the catalyst precursor is converted to the catalyst particles in the water preheater such that the supercritical water stream comprises water at supercritical conditions and the catalyst particles, where the catalyst particles comprise metal oxides, where the Reynolds number of the pressurized water stream is greater than 6,000;
increasing a pressure of the feed oil in an oil pump to produce a pressurized oil stream, where the feed oil comprises heavy oil;
increasing a temperature of the pressurized oil stream in an oil preheater to produce a hot oil stream;
mixing the supercritical water stream and the hot oil stream in a mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
introducing the mixed stream to a reactor, where the reactor is operated at a temperature between 380° C. and 500° C. and a pressure between 22 MPa and 35 MPa;
processing the heavy oil in the reactor in the presence of the catalyst particles to produce a reactor effluent, where the catalyst particles catalyze upgrading reactions of the heavy oil;
reducing a temperature of the reactor effluent in a cooling unit to produce a cooled effluent; and
reducing a pressure of the cooled effluent in a pressure let-down device to produce the SCW effluent.

3. The integrated catalytic process of claim 1, further comprising the steps of:
increasing a pressure of the catalyst precursor solution in a precursor pump to produce a pressurized precursor solution;
increasing a pressure of the feed water in a water pump to produce a pressurized feed water;
increasing a temperature of the pressurized feed water in a water preheater to produce a supercritical water feed;
mixing the supercritical water feed with the pressurized precursor solution in a catalyst mixer to produce a supercritical water stream, where the supercritical water stream is at a temperature between 374° C. and 500° C. and a pressure between 22 MPa and 35 MPa;
withdrawing the supercritical water stream to a process line connecting the catalyst mixer to a mixer, where the catalyst precursor is converted to catalyst particles in the process line such that the supercritical water stream comprises water at supercritical conditions and the catalyst particles, where the catalyst particles comprise metal oxides, where the Reynolds number of the supercritical water stream in the process line is greater than 6,000, where the residence time in the process line is between 0.05 minutes and 10 minutes;
increasing a pressure of the feed oil in an oil pump to produce a pressurized oil stream, where the feed oil comprises heavy oil;
increasing a temperature of the pressurized oil stream to produce a hot oil stream;
mixing the supercritical water stream and the hot oil stream in the mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
introducing the mixed stream to a reactor, where the reactor is operated at a temperature between 380° C. and 500° C. and a pressure between 22 MPa and 35 MPa;
processing the heavy oil in the reactor in the presence of the catalyst particles to produce a reactor effluent, where the catalyst particles catalyze upgrading reactions of the heavy oil;
reducing a temperature of the reactor effluent in a cooling unit to produce a cooled effluent; and
reducing a pressure of the cooled effluent in a pressure let-down device to produce the SCW effluent.

4. The integrated catalytic process of claim 1, further comprising the steps of:
increasing a pressure of the catalyst precursor solution in a precursor pump to produce a pressurized precursor solution;
increasing a pressure of the feed water in a water pump to produce a pressurized feed water;
increasing a temperature of the pressurized feed water in a water preheater to produce a supercritical water feed;
mixing the supercritical water feed with the pressurized precursor solution in a catalyst mixer to produce a supercritical water stream, where the supercritical water stream is at a temperature between 300° C. and 370° C. and a pressure between 22 MPa and 35 MPa;
introducing the supercritical water stream to a catalyst heater;
increasing a temperature of the supercritical water stream in the catalyst heater to produce a catalyst-containing water, where the catalyst precursor is converted to catalyst particles in the catalyst heater such that the catalyst-containing water comprises water at supercritical conditions and the catalyst particles, where the catalyst particles comprise metal oxides, where the Reynolds number of the supercritical water stream in the catalyst heater is greater than 6,000, where the temperature of the catalyst-containing water is in the range between 374° C. and 500° C.;
increasing a pressure of the feed oil in an oil pump to produce a pressurized oil stream, where the feed oil comprises heavy oil;
increasing a temperature of the pressurized oil stream to produce a hot oil stream;
mixing the catalyst-containing water and the hot oil stream in a mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
introducing the mixed stream to a reactor, where the reactor is operated at a temperature between 380° C. and 500° C. and a pressure between 22 MPa and 35 MPa;
processing the heavy oil in the reactor in the presence of the catalyst particles to produce a reactor effluent, where the catalyst particles catalyze upgrading reactions of the heavy oil;
reducing a temperature of the reactor effluent in a cooling unit to produce a cooled effluent; and
reducing a pressure of the cooled effluent in a pressure let-down device to produce the SCW effluent.

5. The integrated catalytic process of claim 1, further comprising the steps of:
increasing a pressure of the catalyst precursor solution in a precursor pump to produce a pressurized precursor solution;
increasing a pressure of the feed water in a water pump to produce a pressurized feed water;
increasing a temperature of the pressurized feed water in a water preheater to produce a supercritical water feed;
mixing the supercritical water feed with the pressurized precursor solution in a catalyst mixer to produce a supercritical water stream, where the supercritical water stream is at a temperature between 374° C. and 500° C. and a pressure between 22 MPa and 35 MPa;
introducing the supercritical water stream to a catalyst pressure control;
reducing a pressure of the supercritical water stream in the catalyst pressure control to produce a pressure regulated catalyst stream, where the catalyst precursor is converted to catalyst particles in the process line downstream of the catalyst pressure control such that the pressure regulated catalyst stream comprises water at supercritical conditions and the catalyst particles, where the catalyst particles comprise metal oxides, where the Reynolds number of the pressure regulated catalyst stream is greater than 6,000, where the temperature of the pressure regulated catalyst stream is in the range between 374° C. and 500° C.;
increasing a pressure of the feed oil in an oil pump to produce a pressurized oil stream, where the feed oil comprises heavy oil such that the pressure of the pressurized precursor solution and the pressurize feed water is at least 0.1 MPa greater than the pressure of the pressurized oil stream;
increasing a temperature of the pressurized oil stream to produce a hot oil stream;
mixing the pressure regulated catalyst stream and the hot oil stream in a mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
introducing the mixed stream to a reactor, where the reactor is operated at a temperature between 380° C. and 500° C. and a pressure between 22 MPa and 35 MPa;
processing the heavy oil in the reactor in the presence of the catalyst particles to produce a reactor effluent, where the catalyst particles catalyze upgrading reactions of the heavy oil;
reducing a temperature of the reactor effluent in a cooling unit to produce a cooled effluent; and
reducing a pressure of the cooled effluent in a pressure let-down device to produce the SCW effluent.

6. The integrated catalytic process of claim 1, where the catalyst precursor comprises a cation and an anion.

7. The integrated catalytic process of claim 6, wherein the cation is selected from the group consisting of transition metals from periods 4 to 6, groups 4 to 12 of the periodic table, cerium, and combinations of the same.

8. The integrated catalytic process of claim 6, wherein the anion is selected from the group consisting of sulfates, chlorides, acetates, acetyl acetonate, formates and combinations of the same.

9. The integrated catalytic process of claim 1, further comprising the steps of:
mixing the hydrogen gas and a hydrogen recycle stream in a hydrogen mixer to produce a hydrogen feed;
compressing the hydrogen feed to produce a compressed hydrogen feed;
mixing the SCW residue product with a residue recycle in a residue mixer to produce a residue feed;
increasing a pressure of the residue feed in a residue pump to produce a pressurized residue feed;
introducing the hydrogen feed to a slurry reactor;
introducing the pressurized residue feed to the slurry reactor;
treating the residue feed in the presence of hydrogen and the catalyst particles in the slurry reactor to produce a slurry effluent; and
separating the slurry effluent in a fractionator unit to produce the product gas stream and the upgraded oil product.

10. An integrated catalytic system for upgrading a feed oil, the integrated catalytic system comprising:
a supercritical water (SCW) process unit, the SCW process unit configured to treat a catalyst precursor solution, a feed water, and the feed oil to produce a SCW effluent, where a catalyst precursor solution comprises a catalyst precursor dissolved in liquid water, where the catalyst precursor is converted to catalyst particles in the SCW;
a separator unit fluidly connected to the SCW process unit, the separator unit configured to separate the SCW effluent to produce a SCW product gas, a SCW distillate product, a SCW residue product, and a water product, where the SCW residue product comprises the catalyst particles; and
a slurry hydroprocessing unit fluidly connected to the separator unit, where slurry hydroprocessing unit is configured to treat the SCW residue product and a hydrogen gas to the slurry hydrproces sing unit to produce a product gas stream and an upgraded oil product.

11. The integrated catalytic system of claim 10, further comprising:
a catalyst mixer configured to mix the feed water with the catalyst precursor solution to produce a metal-containing water stream;
a water pump fluidly connected to the catalyst mixer, the water pump configured to increase a pressure of the metal-containing water stream to produce a pressurized water stream;
a water preheater fluidly connected to the water pump, the water preheater configured to increase a temperature of the pressurized water stream to produce a supercritical water stream, where the supercritical water stream is at a temperature between 374° C. and 500° C. and a pressure between 22 MPa and 35 MPa, where the catalyst precursor is converted to the catalyst particles in the water preheater such that the supercritical water stream comprises water at supercritical conditions and the catalyst particles, where the catalyst particles comprise metal oxides, where the Reynolds number of the pressurized water stream is greater than 6,000;
an oil pump configured increase a pressure of the feed oil to produce a pressurized oil stream, where the feed oil comprises heavy oil;
an oil preheater fluidly connected to the oil pump, the oil preheater configured to increase a temperature of the pressurized oil stream to produce a hot oil stream;
a mixer configured to mix the supercritical water stream and the hot oil stream to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
a reactor fluidly connected to the mixer, the reactor configured to process the heavy oil in the presence of the catalyst particles to produce a reactor effluent, where the catalyst particles catalyze upgrading reactions of the heavy oil, where the reactor is operated at a temperature between 380° C. and 500° C. and a pressure between 22 MPa and 35 MPa;
a cooling unit fluidly connected the reactor, the cooling unit configured to reduce a temperature of the reactor effluent to produce a cooled effluent; and
a pressure let-down device fluidly connected to the cooling unit, the pressure let-down device configured to reduce a pressure of the cooled effluent to produce the SCW effluent.

12. The integrated catalytic systems of claim 10, further comprising the steps of:
a precursor pump, the precursor pump configured to increase a pressure of the catalyst precursor solution to produce a pressurized precursor solution;
a water pump configured to increase a pressure of the feed water to produce a pressurized feed water;
a water preheater fluidly connected to the water pump, the water preheater configured to increase a temperature of the pressurized feed water in to produce a supercritical water feed;
a catalyst mixer, the catalyst mixer configured to mix the supercritical water feed with the pressurized precursor solution to produce a supercritical water stream, where the supercritical water stream is at a temperature between 374° C. and 500° C. and a pressure between 22 MPa and 35 MPa;
a process line connecting the catalyst mixer to a mixer, where the catalyst precursor is converted to catalyst particles in the process line such that the supercritical water stream comprises water at supercritical conditions and the catalyst particles, where the catalyst particles comprise metal oxides, where the Reynolds number of the supercritical water stream in the process line is greater than 6,000, where the residence time in the process line is between 0.05 minutes and 10 minutes;
an oil pump configured increase a pressure of the feed oil to produce a pressurized oil stream, where the feed oil comprises heavy oil;
an oil preheater fluidly connected to the oil pump, the oil preheater configured to increase a temperature of the pressurized oil stream to produce a hot oil stream;
the mixer configured to mix the supercritical water stream and the hot oil stream to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
a reactor fluidly connected to the mixer, the reactor configured to process the heavy oil in the presence of the catalyst particles to produce a reactor effluent, where the catalyst particles catalyze upgrading reactions of the heavy oil, where the reactor is operated at a temperature between 380° C. and 500° C. and a pressure between 22 MPa and 35 MPa;
a cooling unit fluidly connected the reactor, the cooling unit configured to reduce a temperature of the reactor effluent to produce a cooled effluent; and
a pressure let-down device fluidly connected to the cooling unit, the pressure let-down device configured to reduce a pressure of the cooled effluent to produce the SCW effluent.

13. The integrated catalytic system of claim 10, further comprising:
a precursor pump, the precursor pump configured to increase a pressure of the catalyst precursor solution to produce a pressurized precursor solution;
a water pump configured to increase a pressure of the feed water to produce a pressurized feed water;
a water preheater fluidly connected to the water pump, the water preheater configured to increase a temperature of the pressurized feed water in to produce a supercritical water feed;
a catalyst mixer, the catalyst mixer configured to mix the supercritical water feed with the pressurized precursor solution to produce a supercritical water stream, where the supercritical water stream is at a temperature between 300° C. and 370° C. and a pressure between 22 MPa and 35 MPa;
a catalyst heater fluidly connected to the catalyst mixer, the catalyst heater configured to increase a temperature of the supercritical water stream to produce a catalyst-containing water, where the catalyst precursor is converted to catalyst particles in the catalyst heater such that the catalyst-containing water comprises water at supercritical conditions and the catalyst particles, where the catalyst particles comprise metal oxides, where the Reynolds number of the supercritical water stream in the catalyst heater is greater than 6,000, where the temperature of the catalyst-containing water is in the range between 374° C. and 500° C.;
an oil pump configured increase a pressure of the feed oil to produce a pressurized oil stream, where the feed oil comprises heavy oil;
an oil preheater fluidly connected to the oil pump, the oil preheater configured to increase a temperature of the pressurized oil stream to produce a hot oil stream;
a mixer configured to mix the supercritical water stream and the hot oil stream to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
a reactor fluidly connected to the mixer, the reactor configured to process the heavy oil in the presence of the catalyst particles to produce a reactor effluent, where the catalyst particles catalyze upgrading reactions of the heavy oil, where the reactor is operated at a temperature between 380° C. and 500° C. and a pressure between 22 MPa and 35 MPa;
a cooling unit fluidly connected the reactor, the cooling unit configured to reduce a temperature of the reactor effluent to produce a cooled effluent; and
a pressure let-down device fluidly connected to the cooling unit, the pressure let-down device configured to reduce a pressure of the cooled effluent to produce the SCW effluent.

14. The integrated catalytic system of claim 10, further comprising:
a precursor pump, the precursor pump configured to increase a pressure of the catalyst precursor solution to produce a pressurized precursor solution;
a water pump configured to increase a pressure of the feed water to produce a pressurized feed water;
a water preheater fluidly connected to the water pump, the water preheater configured to increase a temperature of the pressurized feed water in to produce a supercritical water feed;
a catalyst mixer, the catalyst mixer configured to mix the supercritical water feed with the pressurized precursor solution to produce a supercritical water stream, where the supercritical water stream is at a temperature between 300° C. and 370° C. and a pressure between 22 MPa and 35 MPa;
a catalyst pressure control fluidly connected to the catalyst mixer, the catalyst pressure control configured to reduce a pressure of the supercritical water stream to produce a pressure regulated catalyst stream, where the catalyst precursor is converted to catalyst particles in the process line downstream of the catalyst pressure control such that the pressure regulated catalyst stream comprises water at supercritical conditions and the catalyst particles, where the catalyst particles comprise metal oxides, where the Reynolds number of the pressure regulated catalyst stream is greater than 6,000, where the temperature of the pressure regulated catalyst stream is in the range between 374° C. and 500° C.;
an oil pump configured increase a pressure of the feed oil to produce a pressurized oil stream such that the pressure of the pressurized precursor solution and the pressurize feed water is at least 0.1 MPa greater than the pressure of the pressurized oil stream, where the feed oil comprises heavy oil;
an oil preheater fluidly connected to the oil pump, the oil preheater configured to increase a temperature of the pressurized oil stream to produce a hot oil stream;
a mixer configured to mix the supercritical water stream and the hot oil stream to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
a reactor fluidly connected to the mixer, the reactor configured to process the heavy oil in the presence of the catalyst particles to produce a reactor effluent, where the catalyst particles catalyze upgrading reactions of the heavy oil, where the reactor is operated at a temperature between 380° C. and 500° C. and a pressure between 22 MPa and 35 MPa;
a cooling unit fluidly connected the reactor, the cooling unit configured to reduce a temperature of the reactor effluent to produce a cooled effluent; and
a pressure let-down device fluidly connected to the cooling unit, the pressure let-down device configured to reduce a pressure of the cooled effluent to produce the SCW effluent.

15. The integrated catalytic system of claim 10, where the catalyst precursor comprises a cation and an anion.

16. The integrated catalytic system of claim 15, wherein the cation is selected from the group consisting of transition metals from periods 4 to 6, groups 4 to 12 of the periodic table, cerium, and combinations of the same.

17. The integrated catalytic system of claim 15, wherein the anion is selected from the group consisting of sulfates, chlorides, acetates, acetyl acetonate, formates and combinations of the same.

18. The integrated catalytic system of claim 10, further comprising:
a hydrogen mixer configured to mix the hydrogen gas and a hydrogen recycle stream to produce a hydrogen feed;
a compressor fluidly connected to the hydrogen mixer, the compressor configured to compress the hydrogen feed to produce a compressed hydrogen feed;
a residue mixer configured to mix the SCW residue product and a residue recycle to produce a residue feed;
a residue pump fluidly connected to the residue mixer, the residue pump configured to increase a pressure of the residue feed to produce a pressurized residue feed;
a slurry reactor, the slurry reactor configured to treat the residue feed in the presence of the hydrogen gas and the catalyst particles to produce a slurry effluent; and
a fractionator unit fluidly connected to the slurry reactor, the fractionator unit configured to separate the slurry effluent to produce the product gas stream and the upgraded oil product.
